(19) United States
(12) Patent Application Publication
(10) Pub. No.: US 2013/0055393 A1
(43) Pub. Date: Feb. 28, 2013

(54) METHOD AND APPARATUS FOR ENHANCING PRIVACY OF CONTACT INFORMATION IN PROFILE

(71) Applicants: Taek Young Youn, Seongnam (KR); Do Won Hong, Daejeon (KR); Ku Young Chang, Daejeon (KR); Nam Su Jho, Daejeon (KR); Jeong Woon Choi, Daejeon (KR); Jung Yeon Hwang, Suwon (KR)

(72) Inventors: Taek Young Youn, Seongnam (KR); Do Won Hong, Daejeon (KR); Ku Young Chang, Daejeon (KR); Nam Su Jho, Daejeon (KR); Jeong Woon Choi, Daejeon (KR); Jung Yeon Hwang, Suwon (KR)

(73) Assignee: Electronics and Telecommunications Research Institute, Daejeon (KR)

(21) Appl. No.: 13/593,876

(22) Filed: Aug. 24, 2012

(30) Foreign Application Priority Data
Aug. 24, 2011 (KR) 10-2011-0084709

(51) Int. Cl. G06F 21/00

(52) U.S. Cl. 726/23

(57) ABSTRACT

A mobility technology for strengthening safety for an invasion of privacy caused by leakage of contact information is provided. A privacy protection system may include an acquisition attempt detecting unit to detect an external communication terminal that attempts to acquire contact information included in the profile, and an access controller to provide the detected external communication terminal with a right to use the contact information, and to determine whether the contact information is to be provided.

### CROSS-REFERENCE TO RELATED APPLICATION

This application claims the benefit of Korean Patent Application No. 10-2011-0084709, filed on Aug. 24, 2011, in the Korean Intellectual Property Office, the disclosure of which is incorporated herein by reference.

### BACKGROUND

1. Field of the Invention

The present invention relates to a mobility technology that may limit a right to access contact information, such as a phone number or an e-mail address that is registered in a user profile used online, or may place restrictions on a right to use acquired contact information, to prevent the contact information from being indiscriminately acquired and used, so that safety for an invasion of privacy caused by leakage of contact information may be strengthened.

2. Description of the Related Art

A profile for online is used as a means for representing a user, and includes a variety of information regarding the user, depending on purposes. In particular, only a profile may be used to determine reliability, since information regarding a user may be acquired using the profile online. Accordingly, in various services provided online, users' profiles are used importantly.

In particular, due to development of services provided based on social networks, various types of personal information are being released in a profile, and importance of user personal information registered in a profile is increased. However, since information released in a profile include an extremely large amount of information having high relevance to a real life of a corresponding user, a risk of an invasion of privacy is increased.

Leakage of contact information among information in a profile may contain very big risk. For example, e-mails described in a profile may be collected, spam, malignant codes, and the like may be spread. Additionally, contact information, such as a phone number, may be collected, and the collected contact information may be misused in a criminal act, such as stalking and the like.

Currently, to protect information released in a profile, a method of restricting a target m that released the information, based on a relationship with a corresponding user is being used. In other words, a method of permitting only a user having a friendship above a predetermined level to read the released information is used to protect a privacy.

A most basic purpose of a profile is to be released. Accordingly, an access to information released in a profile may need to be unrestricted as possible.

Accordingly, a method for solving an issue caused by leakage of information released in a profile may also need to be designed to protect maximum openness of the information. However, since restricted disclosure of information based on a relationship refers to providing information to only a user with a trust relationship that is already formed, openness of information may not be guaranteed.

Only a method of determining whether information is to be released based on a relationship with a user is known as a method of preventing an indiscriminate access to information while maintaining openness of profile information. In particular, there is no study on a method of preventing a damage caused by contact information that is already released.

### SUMMARY

According to an aspect of the present invention, there is provided a privacy protection system of a profile, including: an acquisition attempt detecting unit to detect an external communication terminal that attempts to acquire contact information included in the profile; and an access controller to provide the detected external communication terminal with a right to use the contact information, and to determine whether the contact information is to be provided.

According to another aspect of the present invention, there is provided an operation method of a privacy protection system of a profile, including: detecting, by an acquisition attempt detecting unit, an external communication terminal that attempts to acquire contact information included in the profile; and providing, by an access controller, the detected external communication terminal with a right to use the contact information, and determining whether the contact information is to be provided.

### EFFECT

According to embodiments of the present invention, it is possible to limit a right to access contact information, such as a phone number or an e-mail address that is registered in an online profile, to prevent the contact information from being indiscriminately exposed to a malicious user.

Additionally, according to embodiments of the present invention, it is possible to limit a right to use released contact information, to prevent a problem from continuously occurring due to contact information that is already exposed.

Moreover, according to embodiments of the present invention, it is possible to restrict automated information collection using software, by requesting a reply to a Completely Automated Public Turing test to tell Computers and Humans Apart (CAPTCHA), to access contact information in a profile.

Furthermore, according to embodiments of the present invention, a reputation system may be introduced, and only a user with sufficient reliability and a reputation maintained above a predetermined level may be permitted to access contact information, and thus it is possible to prevent a malicious user from indiscriminately access the contact information.

In addition, according to embodiments of the present invention, it is possible to protect a variety of information in a profile other than contact information, by controlling a right to access the contact information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a privacy protection system according to an embodiment of the present invention;

FIG. 2 is a diagram illustrating a scheme of controlling an operation of a privacy protection system according to an embodiment of the present invention;

FIG. 3 is a diagram illustrating a Completely Automated Public Turing test to tell Computers and Humans Apart (CAPTCHA) used to limit a right to use released contact information, according to an embodiment of the present invention;

FIG. 4 is a diagram illustrating a scheme of controlling an operation of a privacy protection system according to another embodiment of the present invention;

FIG. 5 is a diagram illustrating an actual contact number and a temporary contact number of a user that are stored in a database, according to an embodiment of the present invention; and

FIG. 6 is a flowchart illustrating an operation method of a privacy protection system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

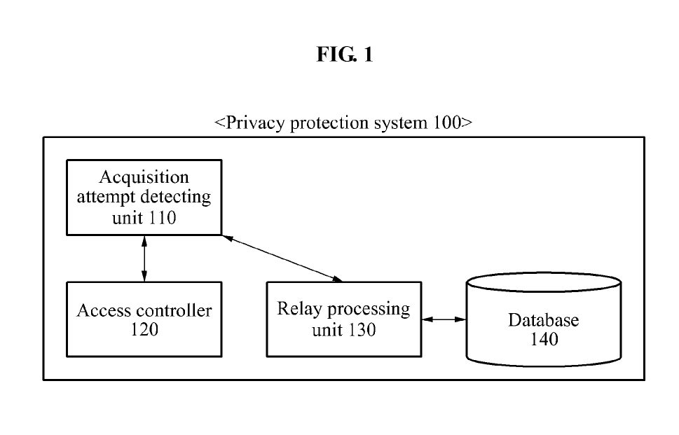

FIG. 1 is a block diagram illustrating a privacy protection system 100 according to an embodiment of the present invention.

The privacy protection system 100 may include an acquisition attempt detecting unit 110, an access controller 120, a relay processing unit 130, and a database 140.

The acquisition attempt detecting unit 110 may detect an external communication terminal that attempts to acquire contact information included in a profile.

The access controller 120 may provide the detected external communication terminal with a right to use the contact information, and to determine whether the contact information is to be provided.

To provide the right to use the contact information, the privacy protection system 100 may use various methods.

For example, the privacy protection system 100 may request the external communication terminal accessing the contact information to input a Completely Automated Public Turing test to tell Computers and Humans Apart (CAPTCHA), and may provide the external communication terminal with the right to use the contact information.

In an example, when the external communication terminal is detected, the access controller 120 may display the CAPTCHA, and may verify reply letters received in response to the displayed CAPTCHA from the detected external communication terminal.

When the displayed CAPTCHA is identical to the reply letters, the access controller 120 may provide the external communication terminal with the right to use the contact information, and may permit an access to the contact information to provide the contact information.

Accordingly, it is possible to protect a privacy by determining whether a user desiring to access the contact information is an actual human or a computer program.

In another example, when the external communication terminal is detected, the privacy protection system 100 may verify reputation information associated with the external communication terminal, and may determine whether the contact information is to be provided.

Specifically, the access controller 120 may collect the reputation information from a reputation system. When the collected reputation information is equal to or greater than a predetermined reference value, the access controller 120 may provide the external communication terminal with the right to use the contact information, and may permit an access to the contact information to provide the contact information.

The reputation system may store the reputation information associated with the external communication terminal.

According to an embodiment of the present invention, a reputation system may be introduced, and only a user with sufficient reliability and a reputation maintained above a predetermined level may be permitted to access contact information. Thus, it is possible to prevent a malicious user from indiscriminately accessing contact information.

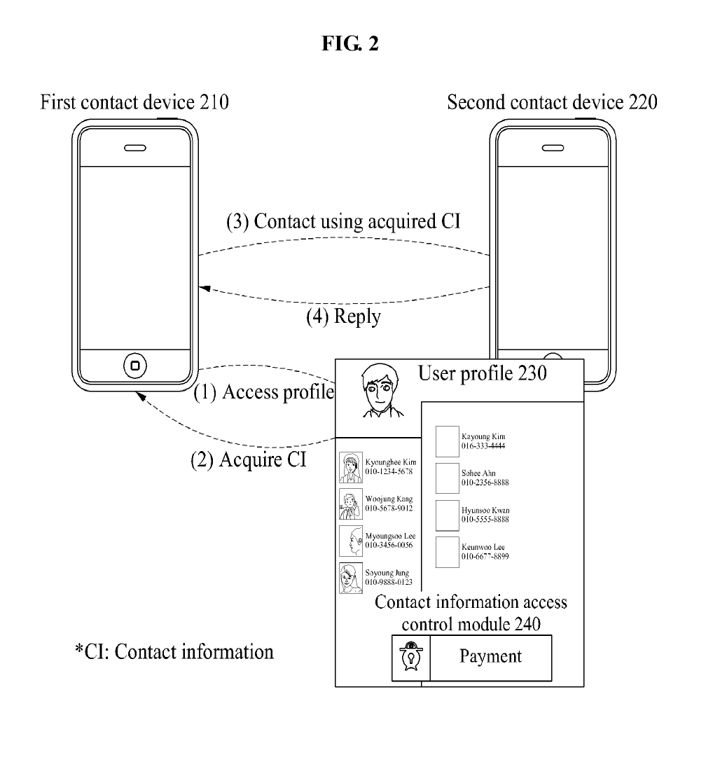

FIG. 2 is a diagram illustrating a scheme of controlling an operation of a privacy protection system according to an embodiment of the present invention.

Referring to FIG. 2, the privacy protection system may include a first contact device 210, and a second contact device 220. The first contact device 210 may be used by a sender attempting to perform communication using contact information registered in a profile. The second contact device 220 may be used by a user who uses contact information posted on a profile to perform communication.

Additionally, the first contact device 210 may attempt to access a user profile 230 of the user using the second contact device 220.

The first contact device 210 and the second contact device 220 may not be limited to a specific hardware device, and may include all devices that may be used to perform a contact using contact information posted on a profile.

The user profile 230 may include a contact information access control module 240. There is no limitation to a configuration of the user profile 230, except the contact information access control module 240.

The contact information access control module 240 may employ a CAPTCHA or a reputation system, to limit a direct access to contact information. Additionally, the contact information access control module 240 may apply both the CAPTCHA and the reputation system, to provide more strengthened safety.

To contact the user using the second contact device 220, the first contact device 210 may access the user profile 230, and may attempt to acquire the contact information.

In this instance, to acquire the contact information, the first contact device 210 may need to receive a permission to access the contact information, through a series of processes applied to the contact information access control module 240.

When a CAPTCHA is applied to the contact information access control module 240, the first contact device 210 may send, to the contact information access control module 240, a reply to the CAPTCHA that is generated and assigned to the first contact device 210 by the contact information access control module 240, and may receive a right to access the contact information.

When a reputation system is applied to the contact information access control module 240, the contact information access control module 240 may permit an access to the contact information, based on a reputation that is managed in association with the first contact device 210, before the contact information is accessed. When the contact information is acquired by the first contact device 210 through the above-described process, the first contact device 210 may communicate with the second contact device 220, based on the acquired contact information.

In other words, since a series of predetermined processes are required to acquire the contact information, it may be difficult for the first contact device 210 to indiscriminately acquire the contact information.

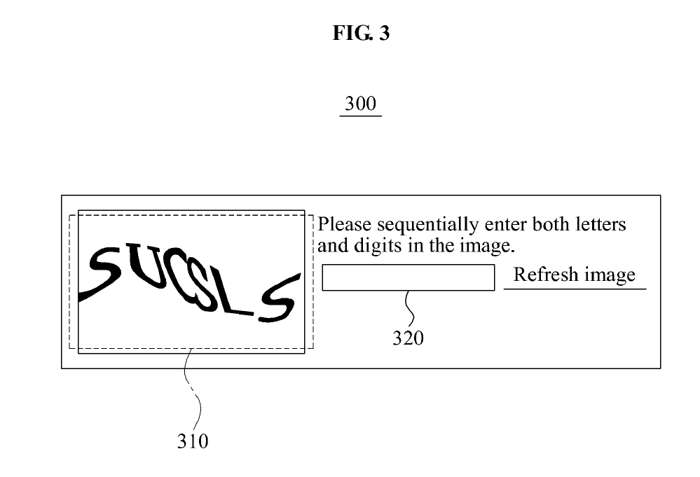

The series of predetermined processes may employ the CAPTCHA, and will be further described with reference to FIG. 3.

FIG. 3 is a diagram illustrating a CAPTCHA used to limit a right to use released contact information, according to an embodiment of the present invention.

When the first contact device 210 accesses the contact information in the profile of the second contact device 220, to acquire the contact information, the privacy protection system may display a CAPTCHA 310. Subsequently, the privacy protection system may receive, as a reply, digits and letters corresponding to the displayed CAPTCHA 310 from the first contact device 210 through a text box 320.

For example, when the first contact device 210 is operated through a computer, the digits and letters corresponding to the displayed CAPTCHA 310 may be incorrectly input.

Accordingly, the privacy protection system may limit, using a CAPTCHA, a right to access contact information, such as a phone number or an e-mail address that is registered in an online profile, to prevent the contact information from being indiscriminately exposed to a malicious user.

In other words, the privacy protection system may restrict automated information collection using software, by requesting a reply to the CAPTCHA to access the contact information in the profile.

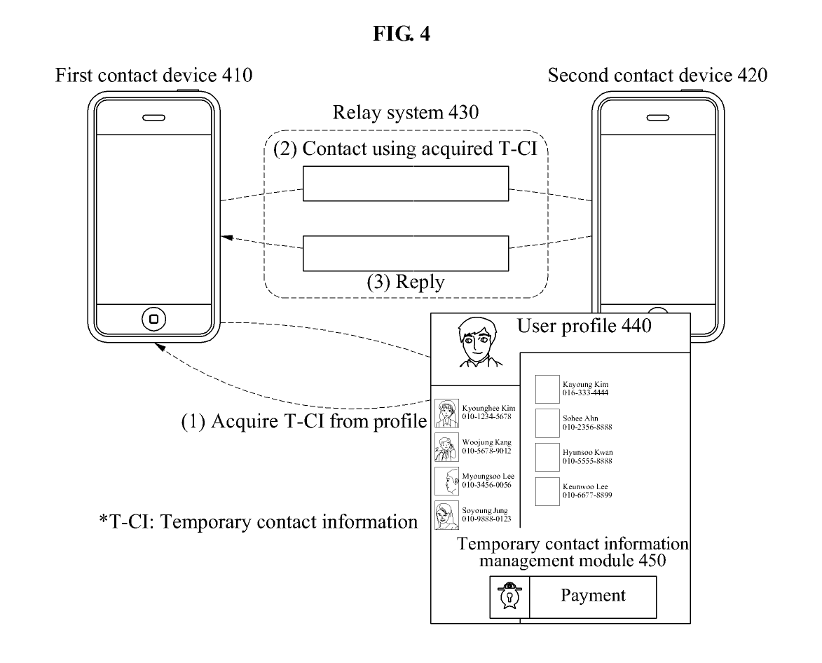

FIG. 4 is a diagram illustrating a scheme of controlling an operation of a privacy protection system according to another embodiment of the present invention.

Referring to FIG. 4, the privacy protection system may broadly include a first contact device 410, a second contact device 420, a relay system 430, and a temporary contact information management module 450. The first contact device 410 may be used by a sender attempting to perform communication using contact information registered in a profile, and the second contact device 420 may be used by a user who uses contact information posted on a profile. The relay system 430 may enable the first contact device 410 and the second contact device 420 to communicate with each other using different contact information. The temporary contact information management module 450 may manage a user profile 440 of the user using the second contact device 420, and contact information that is temporarily used and that is different from actual contact information in a profile.

The first contact device 410 and the second contact device 420 may not be limited to a specific hardware device, and may include all devices that may be used to perform a contact using contact information posted on a profile. The user profile 440 may include temporary contact information, instead of the actual contact information, and may be managed by the temporary contact information management module 450. There is no limitation to a display form of the temporary contact information.

The relay system 430 may be defined as a system to provide a service so that the first contact device 410 used by the sender and the second contact device 420 used by a receiver may perform communication using different contact information.

Additionally, the relay system 430 may include a database, and a relay processing unit. The database may store an actual contact number in association with the contact information in the profile. When communication data is received at the contact information from an external communication terminal, the relay processing unit may parse and detect the actual contact number corresponding to the contact information, and may transfer the communication data at the detected actual contact number.

For example, when reply data to the communication data is received from a communication terminal using the actual contact number, namely, from the second contact device 420, the relay processing unit may set, as a reply number, contact information included in the user profile 440, and may transmit the reply data to an external communication terminal, namely, the first contact device 410.

The relay processing unit may change the contact information in the profile to new contact information, and may control the database to be updated so that the new contact information may be associated with the actual contact number.

For example, when an undesired contact, such as a spam text message and the like, continues at a temporary number, namely the contact information, the user of the second contact device 420 may change the contact information using the relay processing unit, and may match the changed contact information with the actual contact number in the database.

Hereinafter, the scheme of FIG. 4 will be further described with reference to FIG. 2. To contact the user of the second contact device 420, the first contact device 410 may access the user profile 440, and may acquire the temporary contact information managed by the temporary contact information management module 450. When the first contact device 410 attempts to contact based on the acquired temporary contact information, the relay system 430 may transfer information on the attempt of the first contact device 410 to the second contact device 420 used by the receiver using the actual contact information. When the receiver sends a reply to the relay system 430 based on the information received from the relay system 430, the relay system 430 may transfer the reply to the sender based on the temporary contact information, so that the reply may be displayed on the first contact device 410.

As described above, the sender and the receiver may communicate with each other using different contact information.

Various embodiments have been described above in the present specification, however, various modifications may be performed within a scope of the present invention.

In other words, in the present invention, a right to access contact information may be controlled based on a CAPTCHA and a reputation system. However, the present invention is not limited to the described embodiments and drawings, and may be applied within a scope in which a technical aspect of increasing safety by controlling an access to contact information is protected.

Additionally, a scheme of controlling a right to access contact information may equally be applied to information registered in a profile, other than contact information. In addition, controlling of a right to use released contact information based on a relay system may refer to controlling a right to use contact information using a relay system, and accordingly the present invention may also be applied within a scope in which a technical aspect is protected, without a limitation thereto.

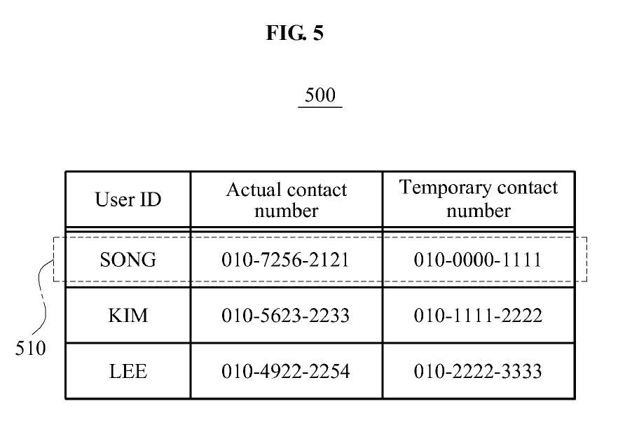

FIG. 5 is a diagram illustrating an actual contact number and a temporary contact number of a user that are stored in a database, according to an embodiment of the present invention.

The database may store temporary contact numbers corresponding to actual contact numbers, for each user.

As indicated by a dotted box 510 of FIG. 5, a user ID “SONG” may be stored in association with an actual contact number “010-7256-2121” and temporary contact number “010-0000-1111.”

For example, when an external communication terminal sends a text message at the temporary contact number “010-0000-1111” that is stored in a profile of a user having the user ID “SONG”, the relay system 430 may transfer the text message at the actual contact number “010-7256-2121” corresponding to the temporary contact number “010-0000-1111”, based on the database.

When a spam text message or an advertising call is frequently received at the temporary contact number “010-0000-1111”, the user having the user ID “SONG” may request the privacy protection system to change the temporary contact number displayed in a profile.

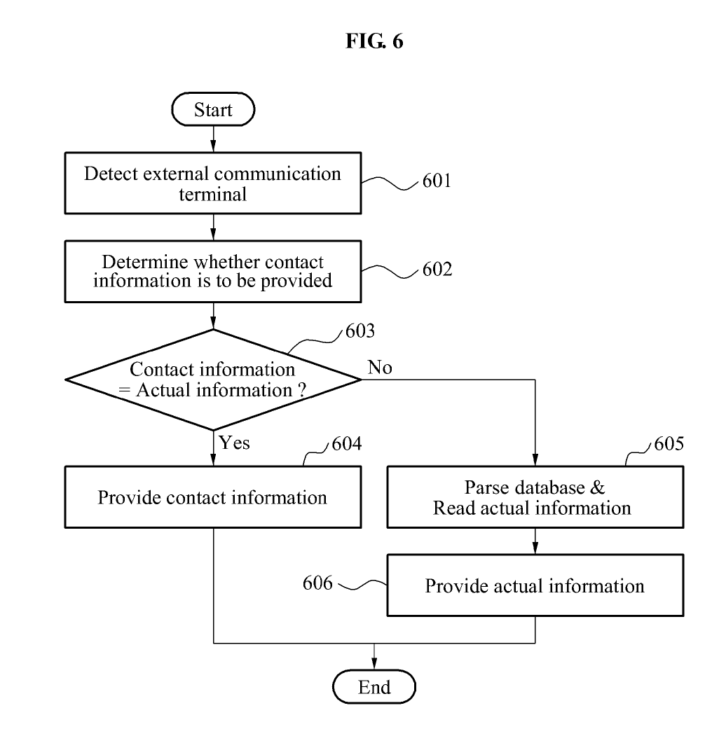

FIG. 6 is a flowchart illustrating an operation method of a privacy protection system according to an embodiment of the present invention.

Referring to FIG. 6, in operation 601, an acquisition attempt detecting unit may detect an external communication terminal that attempts to acquire contact information included in a profile.

In operation 602, an access controller may provide the detected external communication terminal with a right to use the contact information, and may determine whether the contact information is to be provided.

For example, when the right to use the contact information is provided to the external communication terminal, and when the contact information is provided, a determination may be made as to whether the contact information is identical to actual information of a user in operation 603.

When the contact information is identical to the actual information, the contact information may be provided to the external communication terminal in operation 604.

When the contact information is different from the actual information, a database may be parsed, and actual information corresponding to the contact information may be read in operation 605. In operation 606, the read actual information may be provided to the external communication terminal.

According to embodiments of the present invention, it is possible to limit a right to use released contact information, to prevent a problem from continuously occurring due to contact information that is already exposed. In other words, it is possible to protect a variety of information in a profile other than contact information, by controlling a right to access the contact information.

The operation method of the privacy protection system according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A privacy protection system of a profile, comprising:
an acquisition attempt detecting unit to detect an external communication terminal that attempts to acquire contact information included in the profile; and
an access controller to provide the detected external communication terminal with a right to use the contact information, and to determine whether the contact information is to be provided.

2. The privacy protection system of claim 1, wherein, when the external communication terminal is detected, the access controller displays a Completely Automated Public Turing test to tell Computers and Humans Apart (CAPTCHA), and receives reply letters to the displayed CAPTCHA from the detected external communication terminal, and
wherein, when the displayed CAPTCHA is identical to the received reply letters, the access controller provides the external communication terminal with the right to use the contact information, and permits an access to the contact information to provide the contact information.

3. The privacy protection system of claim 1, wherein, when the external communication terminal is detected, the access controller collects reputation information associated with the detected external communication terminal from a reputation system that stores the reputation information,
wherein, when the collected reputation information is equal to or greater than a predetermined reference value, the access controller provides the external communication terminal with the right to use the contact information, and permits an access to the contact information to provide the contact information.

4. The privacy protection system of claim 1, further comprising:
a database to store an actual contact number in association with the contact information; and
a relay processing unit to parse and detect the actual contact number corresponding to the contact information, when communication data is received at the contact information from the external communication terminal, and to transfer the communication data at the detected actual contact number.

5. The privacy protection system of claim 4, wherein, when reply data to the communication data is received from a communication terminal that uses the actual contact number, the relay processing unit sets the contact information as a reply number, and transmits the reply data to the external communication terminal.

6. The privacy protection system of claim 4, wherein the relay processing unit changes the contact information to new contact information, and controls the database to be updated so that the new contact information is associated with the actual contact number.

7. An operation method of a privacy protection system of a profile, the operation method comprising:
detecting, by an acquisition attempt detecting unit, an external communication terminal that attempts to acquire contact information included in the profile; and
providing, by an access controller, the detected external communication terminal with a right to use the contact information, and determining whether the contact information is to be provided.

8. The operation method of claim 7, wherein the providing, when the external communication terminal is detected, comprising:
displaying a Completely Automated Public Turing test to tell Computers and Humans Apart (CAPTCHA);
receiving reply letters to the displayed CAPTCHA from the detected external communication terminal; and
providing the detected external communication terminal with the right to use the contact information, and permitting an access to the contact information to provide the contact information, when the displayed CAPTCHA is identical to the received reply letters.

9. The operation method of claim 7, wherein the providing, when the external communication terminal is detected, comprising:
collecting reputation information associated with the detected external communication terminal from a reputation system that stores the reputation information; and
providing the detected external communication terminal with the right to use the contact information, and permitting an access to the contact information to provide the contact information, when the collected reputation information is equal to or greater than a predetermined reference value.

10. The operation method of claim 7, further comprising:
storing, by a database, an actual contact number in association with the contact information; and
parsing and detecting, by a relay processing unit, the actual contact number corresponding to the contact information, when communication data is received at the contact information from the external communication terminal, and transferring the communication data at the detected actual contact number.
